(19) United States
(12) Patent Application Publication
(10) Pub. No.: US 2005/0182637 A1
(43) Pub. Date: Aug. 18, 2005

(54) Materials for dust product, method wrapping this product and device for manufacture this product bags

(76) Inventors: Liliya Nissim, Brooklyn, NY (US); Sergey Sushchenko, Brooklyn, NY (US)

Correspondence Address: Liliya Nissim, 2nd Floor, 4650 Bedford Ave., Brooklyn, NY, 11235, US

(21) Appl. No.: 10/778,292

(22) Filed: Feb. 12, 2004

(51) Int. Cl. G06F 17/60

(52) U.S. Cl. 705/1

(57) ABSTRACT

The present invention provides materials, method wrapping and device for delivering cement or dust-like product(s) to certain customer (customer is single one, or distributor, or builder of a house, or the plant, or the factory). Paper bag are about 50¢ a piece compared to a plastic bag at about 12¢ a piece. Paper material and device to make paper bag is well known and used already for another purpose, and is provisional of manufactured cement (asbest or dust-like products). Bag(s) from this material and wrapping material covered inside are allow safe product(s) more longer time under good condition during transport and keeping processes. Sensor-information are allow print at the big container all of data about definite customer; manufacture amount product as customer is requested; distribute to definite customer exactly ordered quantity product(s); keep this dust-like product(s) more longer time by manufacturer and customer; constant support of relations and information together manufacturer and customer of dust-like product(s). Manufactured dust-like product(s) is proposed to wrap by special material which is formed bags different capacity as ordered particular customer. Those material analogus hard plastic or another material but covered inside mainly for customer needs. There is device for automatically gives to the operator-informator on a duty, to software, and to certain customer all data and moves about passed distance this cargo (load). All of those changes are directed to increase trade, sale market and export market of dust-like product(s), and finaly make cement trade unknown quantity and more quickly because all of these devices are solve dust-like product(s) problems now.

### CROSS-REFERENCE TO RELATED APPLICATIONS

With reference to the improvement by this invention, and in the discussion with the follows, attention is directed to the prior art. It is well known that in most developing countries, cement is an increasingly important construction material. It is basic to the construction of roads, dams, canals, water and sewer ducts, houses and factories. Since the raw materials are often readily available, cement production can improve a country's living standards and decrease its dependence on imports. But all of dust-like products, as cement it is, have mainly one disadventure: the need to use the product in a short time after manufacture, because it is unavoidably damaged by high humidity and moisture. The other disadventure of this product is locaited inside the first: the delivering and keeping time depends on distance of delivering, transport process, needed safety of dust-like products.

This dust-like industry of the present invention is therefore needed material package to safe products, method of wrapping, and device for this product which can also be easily taken out from these package.

The need for any kind of material for package, information about customer and equipment for the any kind of dust-like products is well-known. Typically, intelligently designed package of this kind of industry is utilized to highly suffer from dust-like products damages and increase trade of dust-like products.

Analists from Kehlen University analized, for instance, the cost of stock exhange of only one American firm to manufacture cement. It is “Tinat Cement NA??”. They are saling $65 at the NY Exhange before begining of bombing of Cosovo in Balkan Republic. They are saling $85 after one month start bombing of Cosovo in Balkan Republic. Investors are desided if something is destroed than cement is needed at first (Russian newspaper published in America “Vecherniy New York”, page 25, Dec. 27, 2002—Jan. 02, 2003, Tel. 718-615-1210, at Internet: www.VechNY.com)

Not so long time ago, the manager of UN who is responsible for the accounts of Banks, said that operate at the Afganistan mean to maintenance relatives, friends, followers (The same as previous: Russian newspaper published in America “Vecherniy New York”, page 25, Dec. 27, 2002—Jan. 02, 2003, Tel. 718-615-1210, at Internet: www.VechNY.com).

From sources which we can reach (books, US Government patents, foreign patents of prototyping, license this kind of patent, companies seeking new material of package, information, and equipment) it is obvious that for any purpose this kind of package, trade of dust-like package which we are proposed in this improvement invention is not used like it was before. It is mean that previous to the present invention, the use of this kind of package have not been before. For instance, we used US Government following patens and results in 1790-2002 db for: “Cement ” and “Package of water”; “Cement” and “manufactured of trade Russian Federation”; “Cement” and “manufactured of trade Ukraine”; “Cement” and “manufactured of trade Uzbekistan”; “Powder products” and “protective for water”; “Powder products” and “package of water”; “Powder products” and “wrapping from water”; “Powder products” and “sealing from water”; “Dust like products” and “protective for water”; “Dust like products” and “protective against water”; “Dust like products” and “wrapper for water”; “Dust like products” and “wrapper against water”; “Moisture-resistant bags of dust products”; “Other containers of dust products”; “Moisture-resistant bags of cement”; “Other containers of cement”; “Cement industry” and “Moisture-Rewsistant Bags”; “Cement” and “Hard-Plastic Bags”; “Cement” and “Plastic Bags Covered Inside Aluminum”; “Dust-Like Products” and “Hard-Plastic Bags”; “Dust-Like Products” and “Plastic Bags Covered Inside Aluminum”; “Dust-Like Products” and “Moisture-Rewsistant Bags”; “Hard-Plastic Bag” and “Covered Inside Aluminum”; “Plastic Bag” and “Covered Inside Another Material”; “Certain Customer” and “Constant Time to Make Order Dust-like Products”; “Definite Customer” and “Constant Time to Make Order Dust-like Products”; “Constant Relationship” and “Manufacturer and Definite Customer”: 0 patents, no patents have matched all of this kind of query. For “Cement” and “protected water” we found fourty (40) US patents which some of them we have used. But the above mentioned and following additional patents also have some relationship to the subject of cement and dust-like products as: U.S. Pat. Nos.: 6,487,651; 6,480,827; 6,475,115; 6,457,640; 5,753,818; 5,955,514; 5,672,384; 5,756,168; 5,091,846; 4,933,835; 4,899,275. These patents are not as pertinent to the subject matter of this invention, however most of them dealing with another material or device, not so close as present invention. For example, we also used Internet Search followings: Quality manufactued cement depends on quality ordered definite customer cement; information ordered customer saved manufacturer table; information ordered customer saved manufacturer software; information ordered customer printed automatically from table; information ordered customer printed automatically from software; a device automatically gives distance this load to operator or/and certain customer; a device automatically gives distance this load to operator or/and definite customer—no matching search listing were found. For instance, we saw only at the article “Benetton is stitch in to the clothes an electronical chips” of Russian newspaper (“Russian Community and Business”, page 4, No. 14 (289), Apr. 8-14, 2003, tel 718-769-3000, fax 718-769-4700 which is published in Manhattan, USA) about electronical very small sensor gives central computer of manufacturer all of path data of goods from produce to the customer of 5000 shops this company, and also all of clothes moves to the computer base to the trade. Mean while Holland Philips Company are produce 15 mln of electronical chips for Benetton. This helps solve clothes retail more fast. More example, we also used articles as, “Portland Cement” prepared by Dane F. Smith and H. W. Goodwin; “The Destruction of Construction; a critique of the cement industry” by Roger Moody; “United States Gypsum Company Will Open New Joint Compound Plant in Arisona” Apr. 25, 2002, source: PR Newswire; A devece packing products by different material around accordingly needed dimencions, where found Internet sources: www.datacable.co.nz; information technology: student.muskegon.cc.mi.us (additional listing); accounting software product information: www.benchmark-software.co.uk (additional listing); Trak System RecordTrak Software Information: www.traksys.com (additional listing); www.wbcsd.org; www.wbcsdcement.org; http://stacks.msnbc.com/local/wgem/m163649.asp. Also we have used WIPO Search for cement and for dust-like products as well. We found a few results and used same of them, for instance, as mentioned a few above.

### FEDERALLY SPONSORED RESEARCH OR DEVELOPMENT

The present application is a Continuation of:
(1) application # 60/441,271, filing date Jan. 21, 2003, confirmation # 6052, date mailed Apr. 9, 2003, entitled, “Materials for dust product, method for wrapping and device for manufacture bags those products”, license for foreign filing under title 35, United States Code, Section 184 Title 37, Code of Federal Regulations, 5.11 & 5.15,

The present application is a Continuation in Part of:
(1) disclosure document No. 537832, filing date Sep. 2, 2003, date mailed to author Oct. 2, 2003, entitled, “MECHANICAL SYSTEM AND IT'S MICROINTEGRATED CIRCUITS,” Organization OIPE DD, Bldg/Room CP2, United States Patent and Trademark Office—1652 (8/99).
(2) disclosure document No. 539315, filing date Sep. 12, 2003, date mailed to author Oct. 23, 2003, entitled, “Device for Produce Microintegrated Circuits of Medicine Dose Intake,” authors Liliya Nissim, Sergey Sushchenko, Organization OIPE DD, Bldg/Room CP2, United States Patent and Trademark Office—1652 (8/99).
(3) disclosure document No. 539375, filing date Sep. 29, 2003, date mailed to author Oct. 23, 2003, entitled, “System of Diagnosis, Medication Dose Intake, and Treatment”, authors Shifman M., Shifman Y., Nissim L., Sushchenko S., Organization OIPE DD, Bldg/Room CP2, United States Patent and Trademark Office—1652 (8/99).

### BACKGROUND OF THE INVENTION

### FIELD OF THE INVENTION

The present invention relates to wrapping material of dust-like products—cement, concrete, asbest, and the same—exactly as ordered particular customer, and for information technology allows to deliver certain quality and quantity manufactured dust-like product(s) to particular customer, and device for manufacture delivered bags different size and dimencions as well.

### SUMMARY OF THE INVENTION

### BRIEF DESCRIPTION OF THE VIEW OF THE DRAWING

Reference being made to the accompanying drawings of the present invention in which: on the every pictures the number before dot (point) is mentioned the number of certain figure, number after dot (point) is mentioned the position of this certain figure, and two doted lines mentioned a cut of this certain figure, where:

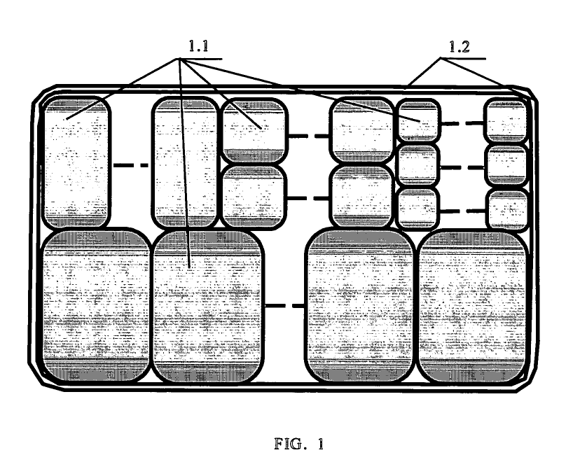

On FIG. 1 is vertical cross-sectional view distributed dust-like product(s) to certain customer according to the one embodiment of the present invention.

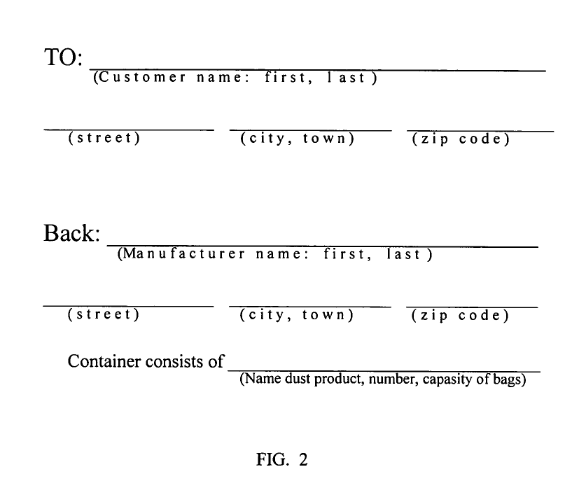

On FIG. 2 shown a view of big bag with saved common information on diskete (flopy disk) or on CD (compact disk) and tiped on the same big bag.

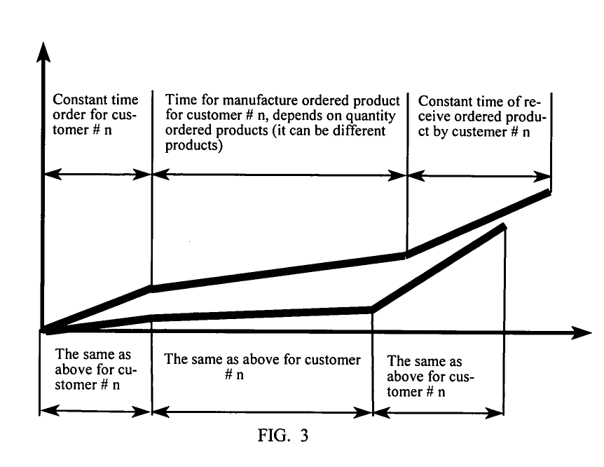

On FIG. 3 is a scetch of saved time, data ordered dust-like product(s) and customer number in common sence.

### BRIEF DESCRIPTION OF THE PRESENT INVENTION

The goal of this present invention is mainly to increase manufacture of these bags and parts of them in common case, and to increase assembly of these parts. The goal of this present invention is also to increase all of customer(s) data for manufacturer(s) of dust-like product(s), and also to increase all of manufacturer(s) data for customer(s) about dust-like product(s) as well. Also goal of this present invention is mainly to increase manufacture of dust-like product(s) wrapping assembly to make certain vacuum to save these dust-like product(s). Also all of these special bag(s) include microintegrated circuit(s) and particle analysis, and bacteria grouth analysis in product(s) as well.

The present invention provides system and method which possess all of the advantages of dust-like product(s) wrapping the advanced bag(s) which have increased or remain safe quality dust-like product(s), and hold substance this product(s) in non-bacteria atmosphere. There briefly described what is shown on each FIGS. 1 to 3, and we have shown all of main parts on each figures embodiment the product(s) and package these products of the present invention. It will be apparent that any previous manufactured dust-like product(s) can be employed in conjunction with either of the other a few expedients used to increase manufacture of dust-like product(s) or remain safe quality of this proposed product(s) and special package(s). There also described what can package have to be after manufacture of dust-like product(s) with example at particular figure. Thereby, this invention works very easy, and also there is not needed to describe work of this one in detail. The package of manufactured product can be maked with hard plastic or another material board as needed this product(s).

There are now hundreds of different types of plastic, and other are being developed. New materials and processes may provide solutions, but in the meantime, scientists are developing more environmentally friendly materials for this new millennium. Foamed metals, for instance, use fewer row materials, making them lighter but still just as strong (Future, by Michael Tambini, p. 54—Lighter Than Air). There are multiple applications of this technology and a great many potential commercial and governmental markets. For instance, “paper bags are about 50¢ a piece compared to a plastic bag at about 12¢ a piece. The city council is reviewing the different options on the table before asking for bids” (http://stacks.msnbc.com/local/wgem/m163649.asp).

The present invention provides package (materials, information and device) which possess all of the advantages of this kind package and manufacture various kind of this product(s) in package in good condition or remain safe quality and quantity during transport process, keep this product(s) in good condition at keeping process as well, and also keep this product in good condition during sale.

There are now hundreds of different types of plastic, and other are being developed. New materials and processes may provide solutions, but in the meantime, scientists are developing more environmentally friendly materials for this new millennium. Foamed metals, for instance, use fewer row materials, making them lighter but still just as strong (Future, by Michael Tambini, p. 54—Lighter Than Air). There are multiple applications of this technology and a great many potential commercial and governmental markets. For instance, “paper bags are about 50¢ a piece compared to a plastic bag at about 12¢ a piece. The city council is reviewing the different options on the table before asking for bids” (http://stacks.msnbc.com/local/wgem/m163649.asp).

The present invention provides package (materials, information and device) which possess all of the advantages of this kind package and manufacture various kind of this product(s) in package in good condition or remain safe quality and quantity during transport process, keep this product(s) in good condition at keeping process as well, and also keep this product in good condition during sale.

While the particular package and it manufacture as herein shown and briefly described is fully capable of attaining described objects of the invention, it is to be understood that it is the presently preferred embodiment of the present invention and thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims.

### DETAILED DESCRIPTION OF THE PRESENT INVENTION

On FIG. 1 is vertical cross-sectional view distributed dust-like product to certain customer according to the one embodiment of the present invention where 1.1 are bags of different capacity (volume) which contain manufactured dust-like product(s); 1.2 is big bag wrapped all of smaller bags. This is mainly increased manufacturing of dust-like product(s), is mainly increased manufacturing special bags and parts of them in common case, and is increased assembly of these parts.

On FIG. 2 shown a view of big bag with saved common information on diskete (flopy disk) or on CD (compact disk) and tiped on the same big bag. Format or/and font these information is varied depends on dimension these big bag, and also saved information about certain customer.

On FIG. 3 is a scetch of saved time, data ordered dust-like product(s) and customer number in common sence. It is possible for presence of microintegrated circuit(s) only inside of one—big bag. It is cut cost big bag(s). The presence of microintegrated circuit(s) inside manufacturing dust-like product(s), and particle analysis, and bacteria grouth analysis in product(s) have increased manufacturing dust-like product(s) itself as well.

Manufacturer also can ask customer to put back this microintegrated circuit. This decreased manufacturing big bag as well.

It will be apparent that any previous transport process of food can be employed in conjunction with either of the other a few expedients used to increased or remain safe quality of this kind not hazardous for environment substances.

The rest particular assembly of product(s) and method of it manufacture has been fully described in connection with the preferred embodiments thereof with reference to the accompanying drawings, it is to be noted that various changes and modifications will be apparent to those skilled in the art. Such changes and modifications are to be understand as included within the scope of the present invention as defined by the appended claims unless they depart therefrom.

1. A material for moisture-resistant bag(s) for dust-like product(s) is mainly hard plastic covered mainly inside by mainly aluminium or plurality of another materials.

2. A material as claimed in claim 1 the big said bag for all shipped said dust-like product(s) is the same if said moisture-resistant said material which is needed depends on transport type and said shipped distance.

3. A method deliver certain dust product(s) definite customer and keep said product(s) all time as needed, comprising steps of:
wrapped product said material consist of said moisture-resistant said bag(s);
certain said customer takes constant time for make order said dust-like product(s), and takes said constant time also, but another said time to receive manufactured said product(s);
constant relationship of said manufacturer and said customer;
save information of said manufacturer about said certain customer as software.

4. A method of claim 3 wherein needed said material for said dust-like product(s) consists on said hard plastic bag(s) said covered aluminium said mainly inside or paper bag(s) used before depends on delivered distance and said type of transportation.

5. A method of claim 3 wherein said ordered and said delivered said information for said certain customer are said constant and said depends on also said delivered distance and said type of transportation.

6. A method of claim 3 wherein quantity said manufactured said dust-like product(s) said depends on quantity said ordered product(s) by said certain customer.

7. A method of claim 3 wherein said manufacturer of dust-like product(s) said saved information about said ordered customer in a few file(s)-table(s) as said software.

8. A method of claim 3 wherein said saved information about said ordered customer in a few said file(s)-table(s) as said software is printed automatically after operator-informator press said customer last mane or said customer number with usual common information at the said big bag automatically choosing a format and font of all printed information.

9. A device for packing said dust-like product(s) for said certain customer can make wether paper bag(s) or said hard plastic bag(s) covered aluminium mainly inside or another needed said material diferent capacity and accordingly needed dimencions.

10. A device of claim 9 wherein this said device is helping wrap said big bag around all delivered said bag product(s) to said certain customer.

11. A device of claim 9 wherein this said device is said automatically gives to the said operator-informator all of about shiped said product(s) and said customer number to according said table(s) of said certain customer, and notify said operator-informator on duty about that.

12. A device of claim 9 wherein this said device is said automatically gives to the said operator-informator all of about passed distance of this cargo (load) of said certain customer, and notify said operator-informator on duty and said certain customer during that one.
